(19) United States
(12) Patent Application Publication
(10) Pub. No.: US 2015/0359226 A1
(43) Pub. Date: Dec. 17, 2015

(54) SYNTHETIC BAIT FOR ATTRACTING MARINE ORGANISMS

(71) Applicant: CRUSHtacean, Inc., Ringgold, VA (US)

(72) Inventors: Terry E Brady, Fort Lauderdale, FL (US); Anthony Lee Dellinger, Browns Summit, NC (US); Christopher Lynn Kepley, Ringgold, VA (US)

(21) Appl. No.: 14/659,710

(22) Filed: Mar. 17, 2015

Related U.S. Application Data
(60) Provisional application No. 62/010,702, filed on Jun. 11, 2014.

(51) Int. Cl. A01N 47/44; A01N 43/08; B29C 39/00; A01N 33/02; A01N 41/08; A01N 43/38; A01N 37/02; A01N 37/18

(52) U.S. Cl. CPC A01N 47/44; A01N 37/02; A01N 43/08; A01N 37/18; A01N 33/02; A01N 41/08; A01N 43/38; B29C 39/003; B29L 2031/702

(57) ABSTRACT

Described herein are synthetic bait compositions and methods for manufacturing synthetic baits that dissolve instantaneously in aqueous media or over a period of seconds up to about 40 days and attract marine organisms. The synthetic baits utilize chemotactic cues to attract marine organisms.

### CROSS REFERENCE TO RELATED APPLICATIONS

This application claims priority to U.S. Provisional Patent Application No. U.S. 62/010,702, filed on Jun. 11, 2014, which is incorporated by reference herein in its entirety. This application is related to International Patent Application No. PCT/US2015/______ filed on Mar. 17, 2015, which is incorporated by reference herein in its entirety.

### TECHNICAL FIELD

Described herein are synthetic bait compositions and methods for manufacturing synthetic baits that dissolve instantaneously in aqueous media or over a period of seconds up to about 40 days and attract marine organisms. The synthetic baits utilize chemotactic cues to attract marine organisms.

### BACKGROUND

The catch, capture, and harvesting of fish and crustaceans (e.g., crabs and lobsters) has been occurring since the early 1600's. Today, the industry is thriving and the market value is estimated to be in the billions of dollars. Fishermen use crab or lobster pots that are baited with rotting flesh either from dead fish or from fish heads (mackerel, herring, red fish, salmon, menhaden, etc.), chicken, cow skin, or other types of flesh. Bait is typically caught by large fishing boats out at sea, salted, and brought in to bait dealers who distribute the bait to smacks and/or directly to the lobster/crab fishermen. Upon distribution, fisherman load pots (or portable traps) with the bait and drop them on to the sea floor. The lobsters or crabs crawl into the trap head (the knitted entryway). The head is tilted so that once the lobster or crab enters the trap it cannot get back out until the fisherman opens the trap and takes the catch out for measuring.

In addition, many commercial and recreational fishermen use “chum” comprised of macerated or chopped fish or animal flesh to attract fish to the angling vicinity. Chum is inconvenient, messy, often odorous, and is difficult to transport and preserve at sea.

Obtaining liver or dead flesh-based bait can be both time-consuming and expensive. Overfishing for bait negatively affects the environment by depleting various fish populations. The capture, preparation, and transport of natural bait are expensive, inconvenient, and odorous. In addition, the rapid decomposition of these baits causes commercial fisherman to make frequent trips to restock traps.

Thus, a need exists for a sustainable, cost effective bait for fish and crustaceans that provides either rapid release of attractants or controlled release of attractants in a stable, long lasting form; that is easily manufactured; that can be transported and stored without refrigeration; and reduces the negative impact on the environment.

### SUMMARY

One embodiment described herein is a synthetic bait composition for attracting marine organisms comprising: at least one inert vehicle; at least one film-forming polymer; at least one solvent; and (d) at least one attractant. In one aspect, the synthetic bait composition dissolves over about a period of about 0.5 seconds to about 40 days in an aqueous medium.

Another embodiment described herein is a synthetic bait composition for attracting marine organisms comprising: calcium sulfate; collagen; gelatin; water; and one or more attractants. In one aspect, the synthetic bait composition dissolves over about a period of about 0.5 seconds to about 40 days in an aqueous medium. In another aspect, the attractants comprise one or more of putrescine, isovaleric acid, butyric acid, ascorbic acid, glutamine, taurine, or creatine. In another aspect, the attractants comprise one or more of putrescine, isovaleric acid, butyric acid, spermidine, cadaverine, or skatole.

Another embodiment described herein is a synthetic bait composition for attracting marine organisms comprising: calcium sulfate; collagen; gelatin; water; putrescine, isovaleric acid, butyric acid, ascorbic acid, glutamine, taurine, and creatine.

Another embodiment described herein is a synthetic bait composition for attracting marine organisms comprising: calcium sulfate; collagen; gelatin; water; putrescine, isovaleric acid, butyric acid, spermidine, cadaverine, and skatole.

Another embodiment described herein is a synthetic bait composition for attracting marine organisms comprising: (a) about 0.01% to about 75% by weight of at least one inert vehicle; (b) about 0.01% to about 25% by weight of at least one film-forming polymer; (d) about 20% to about 85% by weight of at least one solvent; and (d) about 0.5% to about 40% by weight of at least one attractant; and wherein synthetic bait formed from the composition dissolves over about a period of about 0.5 seconds to about 40 days in an aqueous medium. In one aspect described herein, the inert vehicle comprises one or more of calcium sulfate (gypsum), calcium hydroxide, calcium carbonite, silicates, bentonite, Portland cement, clays, sand, or combinations thereof. In another aspect described herein, the film-forming polymer comprises one or more of gelatin, hydrolyzed gelatin, collagen, alginate, agarose, agar, carrageenan, plant gums, hydroxypropylmethylcellulose, ethylcellulose, cellulose, acrylates, methacrylates, or combinations thereof. In another aspect described herein, the solvent comprises one or more of water, seawater, glycerol, sorbitol, polyethylene glycol, propylene glycol, or combinations thereof. In another aspect described herein, the attractants comprise one or more of acetylcholine chloride, N-acetyl-D-glucosamine, adenine, adenosine, adenosine monophosphate, β-alanine, L-alanine, 2-aminoethanol, R-amino-n-butyric acid, ammonia, ammonium chloride, ammonium sulfide, aniline, L-arginine, L-ascorbic acid, L-asparagine, L-asparatic acid, betaine, butanethiol, butyric acid, cadaverine, caproic acid, D/L-carnitine HCl, L-carnosine, citric acid, L-citrulline, coumarin, creatine, p-cresyl isovalerate, L-cysteine, dimethylamine, dipropylene glycol, ethanethiol, ethyl mercaptan, ethylamine, fumaric acid, D-fructose, D-galactose, D-glucose, L-glutamic acid, L-glutamine, glutathione, glycine, guanidine HCl, guanine, hexanoic acid, histamine, L-histidine, homarine, hydroxy-L-proline, 5-hydroxytryptamine, hypoxanthine, indole, i-inositol, inosine, inosine monophosphate, inositol, L-isoleucine, L-isoleucine methyl ester HCl, isopropylamine, isovaleric acid, D/L-lactic acid, α-lactose, β-lactose, L-leucine, levulinic acid, L-lysine, maltose, L-malic acid, D-mannitol, mercaptoethanol, L-methionine, methyl mercaptan, N-methyl morpholine, methylamine, 2-naphthalenethiol, nicotinic acid, D/L-ornithine, pentanethiol, α-picolinic acid, phosphoethanolamine, O-phospho-L-serine, L-proline, propanethiol, propionic acid, propylamine, putrescine, pyruvic acid, quinine, D-ribose, sarcosine, L-serine, skatole, sodium saccharin, D-sorbitol, spermidine, succinic acid, sucrose, taurine, thioglycolic acid, trimethylamine, L-tryptophan, L-tyrosine, urea, uric acid, uridine monophosphate, N-valeric acid, L-valine, or mixtures or combinations thereof. In another aspect described herein, the attractants comprise one or more of creatine monohydrate, butyric acid, ascorbic acid, glutamate, putrescine, cadaverine, isovaleric acid, trimethylamine, glutamine, taurine, spermidine, skatole, or combinations thereof. In another aspect described herein, the composition contains one or more of coloring agents, opacifiers, preservatives, or combinations thereof. In another aspect described herein, the composition is molded to resemble a natural marine organism or marine object. In another aspect described herein, the aqueous media is fresh water, brackish water, or seawater.

Another embodiment described herein is a method for attracting marine organisms comprising immersing in an aqueous environment a synthetic bait formed from a composition comprising: (a) about 0.01% to about 75% by weight of at least one inert vehicle; (b) about 0.01% to about 25% by weight of at least one film-forming polymer; (d) about 20% to about 85% by weight of at least one solvent; (d) about 0.5% to about 40% by weight of at least one attractant; and wherein the synthetic bait dissolves over about a period of about 0.5 seconds to about 40 days in an aqueous medium.

Another embodiment described herein is a method for manufacturing synthetic bait for attracting marine organisms comprising the steps: (a) combining one or more inert vehicles and optional preservatives with a solvent to form a mixture; (b) combining one or more film-forming polymer to the mixture of (a); and (c) combining attractants, optional coloring agents, to the mixture of (b) to form a synthetic bait composition. In one aspect described herein, the synthetic bait composition comprises: (a) about 0.01% to about 75% by weight of at least one inert vehicle; (b) about 0.01% to about 25% by weight of at least one film-forming polymer; (c) about 20% to about 85% by weight of at least one solvent; (d) about 0.5% to about 40% by weight of at least one attractant; and wherein the synthetic bait dissolves over about a period of about 0.5 seconds to about 40 days in an aqueous medium. In another aspect described herein, the method of claim further comprises the steps: (d) pouring the synthetic bait composition of (c) into a mold; (e) solidifying the composition in the mold at a temperature of at least about 4° C. to about 25° C.; (f) curing the composition in the mold for at least about 1 hour at about 25° C.; and (g) removing the synthetic bait from the mold. In another aspect described herein, the method of claim further comprises the steps: (d) creating particles, granules, or pellets from the synthetic composition of (c). Another aspect described herein is a synthetic bait produced by the foregoing methods for manufacturing synthetic baits. In one aspect described herein, the synthetic baits are molded. In another aspect described herein, the synthetic baits are powders, particles, granules, or pellets. In another aspect described herein, the synthetic baits are liquids or suspensions.

Another embodiment described herein is a means for attracting a marine organism comprising immersing a synthetic bait in an aqueous medium, wherein the synthetic bait dissolves over about a period of about 0.5 seconds to about 40 days in the aqueous medium. In one aspect described herein, the synthetic bait is immersed in an aqueous medium in a delivery means or dispersal means.

Another embodiment described herein is a kit comprising articles for manufacturing synthetic bait for attracting marine organisms, the kit comprising: (a) one or more containers comprising a synthetic bait composition; (c) one or more molds resembling a marine organism; and (d) instructions for use. In one aspect described herein, the synthetic bait composition comprises: (a) about 0.01% to about 75% by weight of at least one inert vehicle; (b) about 0.01% to about 25% by weight of at least one film-forming polymer; (c) about 0.5% to about 40% by weight of at least one attractant; and (d) optional preservatives and coloring agents. In another aspect described herein, 20-85% by weight of a solvent is provided by an end-user.

Another embodiment described herein is a synthetic bait composition for attracting marine organisms comprising: (a) about 60% to about 85% by weight of at least one solvent; (b) about 0.5% to about 40% by weight of at least one attractant; and wherein the synthetic bait dissolves over about a period of about 0.5 seconds to about 120 seconds. In one aspect described herein, the composition comprises: (a) about 70% solvent; and (b) about 12% putrescine, about 1.6% isovaleric acid, about 1.7% butyric acid, about 6.5% spermidine, about 6.5% cadaverine, and about 0.7% skatole.

Another embodiment described herein is a synthetic bait for attracting marine organisms comprising: (a) about 49% calcium sulfate; (b) about 1% collagen; (c) about 1% gelatin; (d) about 45% water; and (e) about 0.4% putrescine, about 0.1% isovaleric acid, about 0.1% butyric acid, about 0.5% ascorbic acid, about 0.5% glutamine, about 0.5% taurine, or about 0.5% creatine; wherein synthetic bait formed from the composition dissolves over about 1 day to about 2 days in an aqueous medium.

Another embodiment described herein is a synthetic bait for attracting marine organisms comprising: (a) about 56% calcium sulfate; (b) about 1.2% collagen; (c) about 1.2% gelatin; (d) about 36% water; and (e) about 0.7% putrescine, about 0.2% isovaleric acid, about 0.2% butyric acid, about 0.9% ascorbic acid, about 0.9% glutamine, about 0.9% taurine, and about 0.9% creatine; wherein synthetic bait formed from the composition dissolves over about 3 days to about 5 days in an aqueous medium.

Another embodiment described herein is a synthetic bait for attracting marine organisms comprising: (a) about 61% calcium sulfate; (b) about 1.6% collagen; (c) about 1.6% gelatin; (d) about 30% water; and (e) about 0.7% putrescine, about 0.2% isovaleric acid, about 0.2% butyric acid, about 1% ascorbic acid, about 1% glutamine, about 1% taurine, and about 1% creatine; wherein synthetic bait formed from the composition dissolves over about 7 days to about 10 days in an aqueous medium.

Another embodiment described herein is a synthetic bait for attracting marine organisms comprising: (a) about 70% calcium sulfate; (b) about 2.5% collagen; (c) about 2.5% gelatin; (d) about 20% water; and (e) about 0.8% putrescine, about 0.2% isovaleric acid, about 0.2% butyric acid, about 1% ascorbic acid, about 1% glutamine, about 1% taurine, and about 1% creatine; wherein synthetic bait formed from the composition dissolves over about 20 days to about 40 days in an aqueous medium.

Another embodiment described herein is a synthetic bait for attracting marine organisms comprising: (a) about 18% calcium sulfate; (b) about 8% collagen; (c) about 8% gelatin; (d) about 56% water; and (e) about 2% putrescine, about 0.5% isovaleric acid, about 0.5% butyric acid, about 2% spermidine, about 2% cadaverine, and about 0.2% skatole; wherein synthetic bait formed from the composition dissolves over about 60 seconds to about 600 seconds in an aqueous medium.

Another embodiment described herein is a synthetic bait for attracting marine organisms comprising: (a) about 70% solvent; and (b) about 12% putrescine, about 1.6% isovaleric acid, about 1.7% butyric acid, about 6.5% spermidine, about 6.5% cadaverine, and about 0.7% skatole; wherein the synthetic bait dissolves over about a period of about 0.5 seconds to about 120 seconds.

### BRIEF DESCRIPTION OF THE DRAWINGS

FIG. 1 illustrates a schematic of a method for preparing one embodiment of synthetic bait composition as described herein.

FIG. 2 illustrates one embodiment of synthetic bait molded according to the method outlined in FIG. 1 and comprising an attachment loop for easy addition to traps and bait chambers (100 mL bait cake of the composition of Table 4).

FIG. 3 illustrates another embodiment of a synthetic bait cake.

FIG. 4 illustrates another embodiment of synthetic bait cakes having various colors and shaped like sea-scallops.

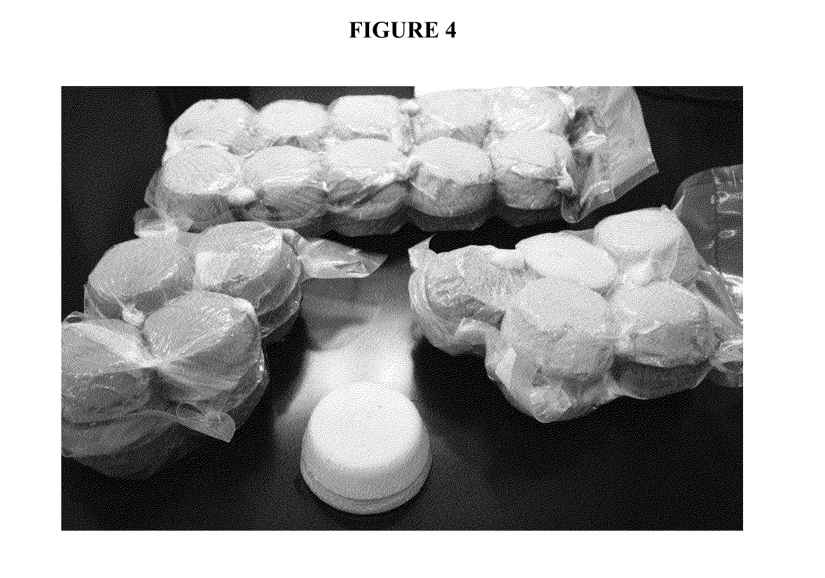

FIG. 5 illustrates another embodiment of a synthetic bait cake molded and colored to resemble a crab.

FIG. 6 illustrates another embodiment of a synthetic bait cake molded and colored to resemble a lobster.

### DETAILED DESCRIPTION

Described herein are synthetic bait compositions and synthetic baits formed therefrom that overcome the negative limitations of flesh-based bait. The synthetic baits described herein comprise a variety of attractants or combinations thereof and release the attractants at various rates, simulating decaying flesh, and attracting marine organisms. Also described herein are methods for preparation thereof. In addition, methods for attracting marine organisms using the baits are described herein. Further, means for implementing the baits and kits for preparing synthetic baits are described.

The synthetic bait compositions, the formed baits, and methods described herein provide an attractive option to traditional fish or flesh-based bait or chum because the synthetic baits utilize attractant molecules that simulate the chemistry of decomposing flesh. The synthetic baits utilize chemotactic cues to attract marine organisms into the vicinity of the bait.

A synthetic bait composition comprising a matrix of calcium sulfate, high-Bloom gelatin, and collagen and various attractants permits the formation of synthetic bait cakes that slowly release the attractant species in aqueous media and provides durability against attacks by trapped lobsters, crabs or the like, water turbulence, and temperature variation.

The finished synthetic bait cakes may be cut and packaged in any shape as desired, and sold in bulk to fisherman.

The synthetic bait cakes described herein thus eliminates wet, rotting, smelly fish/animal parts in dock side storage bins and reliance on insulated and covered “totes” or wet fish boat trays, and an odorous on-board and ashore mess.

One embodiment described herein is a synthetic bait composition that is combined with a solvent and molded to form bait cakes having variable release rates of attractants and that are visually stimulating to marine organisms in terms of their colors and shapes. The synthetic bait cakes described herein can be made in bulk and molded into a variety of marine organism shapes and colors. Once formed, the synthetic bait cakes are easily stored at ambient temperatures and remain intact for up to 30 days in brackish, fresh, or salt-water conditions, while slowly releasing chemical attractants into the water. The synthetic baits can also be made “on the water” by fishermen or anglers, minimally cured, and then readily used. The synthetic baits described herein provide both a sustainable and economical option for fishermen and hobbyists that are independent of bait price variations. Further, the synthetic baits described herein prevent the depletion of fish populations.

Another embodiment described herein is an instantaneous or rapid release bait composition that can be distributed in a finite area or widely dispersed for attracting fish and other marine organisms. The composition of the rapid release bait compositions can be tailored to facilitate diffusion of the attractants both laterally and vertically within the water column. For example, the rapid release bait can be dispersed from a boat to attract fish into the vicinity for commercial or sport fishing.

The term “bait composition” or “composition” as used herein refers to the components used to produce the synthetic baits described herein. In one embodiment described herein, the synthetic bait composition comprises a matrix of one or more inert vehicles, one or more fim-forming polymers, one or more attractants and one or more solvents and optionally coloring agents and preservatives. In another embodiment described herein, the synthetic bait composition comprises one or more attractants, one or more solvents, and optionally coloring agents and preservatives.

The term “synthetic bait,” “synthetic bait cakes,” or “bait,” as used herein refers to the synthetic baits made from the synthetic bait compositions described herein. In one embodiment described herein, the synthetic baits are called “organobaits” because the bait compositions comprise one or more organic species that provide decaying flesh chemotactic cues to marine organisms. In one embodiment, the synthetic baits are solid “cakes” after formation, molding, and curing. In another embodiment, the synthetic baits can be formed into shapes an colored to resemble marine organisms. In another embodiment, the synthetic baits are liquids, suspensions, colloids, emulsions, powders, particles, granules, or pellets.

The term “inert vehicle” as used herein refers to non-reactive compounds that provide weight and mass to the bait composition, giving it structural rigidity, and controlling diffusion of the attractants in an aqueous media.

The term “film-forming polymer” as used herein refers to natural or synthetic polymers that provide increased viscosity and serve as a matrix to suspend one or more attractants.

The term “attractants” as used herein refers to one or more organic species that provide chemotactic cues to marine organisms. In one embodiment described herein, attractants simulate the metabolites of decaying flesh.

The term “coloring agents” as used herein refers to any food coloring or water-soluble dye that can be added to the synthetic baits to provide colors.

The term “aqueous media” as used herein refers to fresh water, brackish water, or seawater.

The term “dissolution time” as used herein refers to the amount of time, such as seconds, minutes, hours, days, or weeks required for a synthetic bait to dissolve completely in an aqueous media. The release rate of organic attractant species in synthetic baits described herein is directly proportional to the dissolution time of the bait. The dissolution time is dependent on several factors including the synthetic bait composition, the size, shape, and mass of the synthetic bait, the temperature of the media, the durability against predator attack, and media agitation or turbulence. The composition of the synthetic baits described herein can be tailored to provide a variety of dissolution times, from second to multiple weeks.

The term “about” as used herein refers to any value that is within a variation of up to ±10% of the value modified by the term “about.”

The term “substantially” as used herein means to a great or significant extent, but not completely.

As used herein, “a” or “an” means one or more unless otherwise specified.

Terms such as “include,” “including,” “contain,” “containing” and the like mean “comprising.”

The term “or” can be conjunctive or disjunctive.

In one embodiment described herein, a synthetic bait composition comprises that shown in Table 1.

TABLE 1
Exemplary Synthetic Bait Composition

| Component | Weight Percentage (%) |
|---|---|
| Inert Vehicle(s) | 0-75 |
| Film-forming Polymer(s) | 0-25 |
| Solvent(s) | 20-85 |
| Attractant(s) | 0.5-40 |
| Optional Coloring Agent(s) | 0-1 |
| Optional Preservative(s) | 0-5 |
| TOTAL | 100% |

Dissolution Profile

| | |
|---|---|
| Dissolution Times | seconds to 40 days |

In another embodiment described herein, a slow dissolving/release synthetic bait composition comprises that shown in Table 2.

TABLE 2
Exemplary Synthetic Bait Composition

| | | Weight |
|---|---|---|
| Component | Exemplary Components | Percentage (%) |
| Inert Vehicle | Calcium Sulfate | 0-75 |
| Film-forming Polymer | Gelatin, 100-300 | 0-10 |
| | Bloom | |
| | Collagen, 100-300 | 0-10 |
| | Bloom | |
| Solvent | Water, glycerol, | 20-85 |
| | PEG 3350 | |
| Exemplary Attractants | Putrescine | 0.5-10 |
| | Isovaleric Acid | 0-1 |
| | Butyric Acid | 0-5 |
| | Ascorbic Acid | 0-5 |
| | Glutamine | 0-5 |
| | Taurine | 0-5 |
| | Creatine | 0-5 |
| Optional Coloring | Dyes, food coloring | 0-1 |
| Agents | | |
| Optional Preservatives | EDTA, sodium benzoate, | 0-5 |
| | NaOH | |
| TOTAL | | 100% |

Dissolution Profile

| | |
|---|---|
| Dissolution Times | Seconds to 40 days |

In another embodiment described herein, a rapid dissolving/releasing synthetic bait composition comprises that shown in Table 3.

TABLE 3
Exemplary Rapid Dissolving Synthetic Bait Composition

| | | Weight |
|---|---|---|
| Component | Exemplary Components | Percentage (%) |
| Inert Vehicle | Calcium Sulfate | 10-20 |
| Film-forming Polymer | Gelatin, 100-300 | 0-10 |
| | Bloom | |
| | Collagen, 100-300 | 0-10 |
| | Bloom | |
| Solvent | Water, glycerol, | 45-65 |
| | PEG 3350 | |
| Exemplary Attractants | Putrescine | 0.5-10 |
| | Isovaleric Acid | 0-1 |
| | Butyric Acid | 0-5 |
| | Spermidine | 0-10 |
| | Cadaverine | 0-10 |
| | Skatole | 0-5% |
| Optional Coloring | Dyes, food coloring | 0-1 |
| Agents | | |
| Optional | EDTA, sodium benzoate, | 0-5 |
| Preservatives | NaOH | |
| TOTAL | | 100% |

Dissolution Profile

| | |
|---|---|
| Dissolution Times | 10-1080 min. |

In another embodiment described herein, an exemplary instantaneous dissolving/releasing synthetic bait composition comprises that shown in Table 4.

TABLE 4
Exemplary Instantaneous Synthetic Bait Composition

| | | Weight |
|---|---|---|
| Component | Exemplary Components | Percentage (%) |
| Solvent | Water, glycerol, PEG | 60-85 |
| Exemplary Attractants | Putrescine | 10-30 |
| | Isovaleric Acid | 1-10 |
| | Butyric Acid | 1-10 |
| | Spermidine | 10-30 |
| | Cadaverine | 10-30 |
| | Skatole | 1-10 |
| Optional Coloring Agents | Dyes, food coloring | 0-1 |
| Optional Preservatives | EDTA, sodium benzoate, | 0-5 |
| | NaOH | |
| TOTAL | | 100% |

Dissolution Profile

| | |
|---|---|
| Dissolution Times | (Instantaneous) |
| | 0.5-120 sec |

In one embodiment described herein, the synthetic bait composition comprises one or more inert vehicles. In one embodiment, the inert vehicle comprises one or more inert high-density minerals including, but not limited to calcium sulfate (gypsum), calcium hydroxide, calcium carbonite, silicates, bentonite, Portland cement, clays, sand, or combinations thereof. In one aspect, the inert vehicle comprises calcium sulfate. In another aspect, the inert vehicle comprises sand and calcium sulfate.

In one embodiment, an inert vehicle comprises a weight percentage of about 0% to about 75% by weight of the synthetic bait composition, including each integer within the specified range. In some embodiments, particularly rapid dissolving, instantaneous dissolving, or liquid forms of the synthetic bait compositions described herein, no inert vehicle is present in the composition. In some embodiments, instantaneous dissolving, or liquid forms of the synthetic bait compositions described herein, the inert vehicle comprises a weight percentage of about 0.01% to about 1% by weight of the synthetic bait composition, including each integer within the specified range. In another embodiment, particularly rapid dissolving of the synthetic bait compositions described herein, the inert vehicle comprises a weight percentage of about 10% to about 20% by weight of the synthetic bait composition, including each integer within the specified range. In another embodiment, the inert vehicle comprises a weight percentage of about 40% to about 75% by weight of the synthetic bait composition, including each integer within the specified range. In one aspect, the inert vehicle comprises about 0.01%, about 0.05%, about 0.1%, about 0.5%, about 1%, about 5%, about 10%, about 15%, about 20%, about 25%, about 30%, about 35%, about 40%, about 45%, about 50%, about 55%, about 60%, about 65%, about 70%, or about 75% by weight of the synthetic bait composition. In another aspect, the inert vehicle comprises about 18% by weight of the synthetic bait composition. In another aspect, the inert vehicle comprises about 49% by weight of the synthetic bait composition. In another aspect, the invert vehicle comprises about 56% by weight of the synthetic bait composition. In another aspect, the inert vehicle comprises about 61% by weight of the synthetic bait composition. In another aspect, the inert vehicle comprises about 69% by weight of the synthetic bait composition.

In another embodiment described herein, the synthetic bait composition comprises one or more film-forming polymers. In one embodiment, the film-forming polymers comprise one or more of gelatin, hydrolyzed gelatin, collagen, alginate, agarose, agar, carrageenan, plant gums, hydroxypropylmethylcellulose, ethylcellulose, cellulose, acrylates, methacrylates, or combinations thereof. In one aspect, film-forming polymers comprise collagen, gelatin, or combinations thereof. In one aspect, film-forming polymer comprises high-Bloom gelatin or collagen, or combinations thereof. In one aspect, film-forming polymers comprise high-Bloom gelatin and collagen.

In another embodiment, one or more film-forming polymers comprise a gelatin having a Bloom value of about 50 to about 300 Bloom. In one embodiment, the Bloom value is about 100 Bloom, about 150 Bloom, about 175 Bloom, about 200 Bloom, about 225 Bloom, about 250 Bloom, about 275 Bloom, about 300 Bloom, about 325 Bloom, about 350 Bloom, about 375 Bloom, or about 400 Bloom. In one aspect, the Bloom value is about 200 Bloom to about 350 Bloom.

In another embodiment, one or more film-forming polymers comprises a total weight percentage of about 0% to about 25% by weight of the synthetic bait composition, including each integer within the specified range. In some embodiments, particularly instantaneous dissolving, or liquid forms of the synthetic bait compositions described herein, no film-forming polymer is present. In some embodiments, particularly instantaneous dissolving, or liquid forms of the synthetic bait compositions described herein, the film-forming polymer comprises a weight percentage of about 0.01% to about 0.5% by weight of the synthetic bait composition, including each integer within the specified range. In one aspect, the film-forming polymers comprise a total weight percentage of about 1%, about 2%, about 3%, about 4%, about 5%, about 6%, about 7%, about 8%, about 9%, about 10%, about 12%, about 14%, about 16%, about 18%, or about 20% by weight of the synthetic bait composition. In one aspect, the film-forming polymers comprise a total weight percentage of about 2% by weight of the synthetic bait composition. In another aspect, the film-forming polymers comprise a total weight percentage of about 2.4% by weight of the synthetic bait composition. In another aspect, the film-forming polymers comprise a total weight percentage of about 3.2% by weight of the synthetic bait composition. In another aspect, the film-forming polymers comprise a total weight percentage of about 4.8% by weight of the synthetic bait composition. In another aspect, the film-forming polymers comprise a total weight percentage of about 8% by weight of the synthetic bait composition. In another aspect, the film-forming polymers comprise a total weight percentage of about 16% by weight of the synthetic bait composition. In another aspect, the film-forming polymers comprise a total weight percentage about 1.5%, about 2.2%, about 2.5%, about 3.5%, about 5%, about 8%, about 10%, or about 16% by weight of the synthetic bait composition.

In another embodiment, the film-forming polymer comprises gelatin having weight percentage of about 0% to about 10% by weight of the synthetic bait composition, including each integer within the specified range. In some embodiments, particularly instantaneous dissolving, or liquid forms of the synthetic bait compositions described herein, gelatin comprises a weight percentage of about 0.01% to about 0.5% by weight of the synthetic bait composition, including each integer within the specified range. In one aspect, gelatin comprises about 0.01%, about 0.05%, about 0.1%, about 0.5%, about 1%, about 2%, about 3%, about 4%, about 5%, about 6%, about 7%, about 8%, about 9%, or about 10% by weight of the synthetic bait composition. In another aspect, gelatin comprises about 1% of the synthetic bait composition. In another aspect, gelatin comprises about 1.2% by weight of the synthetic bait composition. In another aspect, gelatin comprises about 1.6% by weight of the synthetic bait composition. In another aspect, gelatin comprises about 2.4% by weight of the synthetic bait composition. In another aspect, gelatin comprises about 3.2% by weight of the synthetic bait composition. In another aspect, gelatin comprises about 4.8% by weight of the synthetic bait composition. In another aspect, gelatin comprises about 8% by weight of the synthetic bait composition. In another aspect, gelatin is about 1.5%, about 2.2%, about 2.5%, about 3.5%, about 5%, about 8%, or about 10% by weight of the synthetic bait composition.

In another embodiment, the film-forming polymer comprises collagen having weight percentage of about 1% to about 10% by weight of the synthetic bait composition, including each integer within the specified range. In some embodiments, particularly instantaneous dissolving, or liquid forms of the synthetic bait compositions described herein, collagen comprises a weight percentage of about 0.01% to about 0.5% by weight of the synthetic bait composition, including each integer within the specified range. In one aspect, collagen comprises about 0.01%, about 0.05%, about 0.1%, about 0.5%, about 1%, about 2%, about 3%, about 4%, about 5%, about 6%, about 7%, about 8%, about 9%, or about 10% by weight of the synthetic bait composition. In another aspect, collagen comprises about 1% of the synthetic bait composition. In another aspect, gelatin comprises about 1.2% by weight of the synthetic bait composition. In another aspect, collagen comprises about 1.6% by weight of the synthetic bait composition. In another aspect, collagen comprises about 2.4% by weight of the synthetic bait composition. In another aspect, collagen comprises about 3.2% by weight of the synthetic bait composition. In another aspect, collagen comprises about 4.8% by weight of the synthetic bait composition. In another aspect, collagen comprises about 8% by weight of the synthetic bait composition. In another aspect, collagen is about 1.5%, about 2.2%, about 2.5%, about 3.5%, about 5%, about 8%, or about 10% by weight of the synthetic bait composition.

In another embodiment described herein, the synthetic bait composition comprises one or more solvents. In one embodiment, the solvent comprises one or more of water, glycerol, sorbitol, polyethylene glycol (PEG, 100-20,000 MW), propylene glycol, or combinations thereof. In one aspect, the solvent is water. In another aspect, the solvent is seawater. In one aspect, water combined with one or more additives comprising glycerol, sorbitol, polyethylene glycol, propylene glycol, or combinations thereof at additive concentrations from about 1% to about 70%, including each integer within the specified range.

In another embodiment described herein, the solvent comprises a weight percentage of about 20% to about 85% by weight of the synthetic bait composition, including each integer within the specified range. In one embodiment, the solvent comprises about 20%, about 15% about 20%, about 25%, about 30%, about 35%, about 40%, about 45%, about 50%, about 55%, about, 60%, about, 65%, about 70%, about 75%, about 80%, or about 85% by weight of the synthetic bait composition. In another embodiment described herein, the solvent comprises a weight percentage of about 20% to about 50% by weight of the synthetic bait composition, including each integer within the specified range. In another embodiment described herein, the solvent comprises a weight percentage of about 45% to about 65% by weight of the synthetic bait composition, including each integer within the specified range. In another embodiment described herein, the solvent comprises a weight percentage of about 60% to about 85% by weight of the synthetic bait composition, including each integer within the specified range. In one aspect, the solvent comprises about 20%, about 25%, about 30%, about 35%, about 40%, about 45%, about 50%, about 55%, about 60%, about 65%, about 70%, about 75%, about 80%, or about 85% by weight of the synthetic bait. In another aspect, the solvent is about 19% by weight of the synthetic bait composition. In another aspect, the solvent is about 30% by weight of the synthetic bait composition. In another aspect, the solvent is about 36% by weight of the synthetic bait composition. In another aspect, the solvent is about 45% by weight of the synthetic bait composition. In another aspect, the solvent is about 56% by weight of the synthetic bait composition. In another aspect, the solvent is about 69% by weight of the synthetic bait composition. In another aspect, the solvent is about 18%, about 24%, about 28%, about 34%, about 38%, about 42%, about 46%, about 54%, about 58%, about 64%, about 70%, or about 78% by weight of the synthetic bait composition.

In another embodiment described herein, the synthetic bait composition comprises one or more attractants at individual weight percentages comprising about 0.5% to about 20% and total combined weight percentages of 0.5% to about 40%, including all integers within both specified ranges. In one embodiment, the one or more attractants comprise one or more of acetylcholine chloride, N-acetyl-D-glucosamine, adenine, adenosine, adenosine monophosphate, β-alanine, L-alanine, 2-aminoethanol, R-amino-n-butyric acid, ammonia, ammonium chloride, ammonium sulfide, aniline, L-arginine, L-ascorbic acid, L-asparagine, L-asparatic acid, betaine, butanethiol, butyric acid, cadaverine, caproic acid, D/L-carnitine HCl, L-carnosine, citric acid, L-citrulline, coumarin, creatine, p-cresyl isovalerate, L-cysteine, dimethylamine, dipropylene glycol, ethanethiol, ethyl mercaptan, ethylamine, fumaric acid, D-fructose, D-galactose, D-glucose, L-glutamic acid, L-glutamine, glutathione, glycine, guanidine HCl, guanine, hexanoic acid, histamine, L-histidine, homarine, hydroxy-L-proline, 5-hydroxytryptamine, hypoxanthine, indole, i-inositol, inosine, inosine monophosphate, inositol, L-isoleucine, L-isoleucine methyl ester HCl, isopropylamine, isovaleric acid, D/L-lactic acid, α-lactose, β-lactose, L-leucine, levulinic acid, L-lysine, maltose, L-malic acid, D-mannitol, mercaptoethanol, L-methionine, methyl mercaptan, N-methyl morpholine, methylamine, 2-naphthalenethiol, nicotinic acid, D/L-ornithine, pentanethiol, α-picolinic acid, phosphoethanolamine, O-phospho-L-serine, L-proline, propanethiol, propionic acid, propylamine, putrescine, pyruvic acid, quinine, D-ribose, sarcosine, L-serine, skatole, sodium saccharin, D-sorbitol, spermidine, succinic acid, sucrose, taurine, thioglycolic acid, trimethylamine, L-tryptophan, L-tyrosine, urea, uric acid, uridine monophosphate, N-valeric acid, L-valine, trans-4,5-epoxy-(E)-2-decenal, or mixtures or combinations thereof.

In one embodiment described herein, the synthetic bait composition comprises one or more of putrescine, butyric acid, isovaleric acid, cadaverine, spermidine, skatole, ascorbic acid, glutamate, trimethylamine, glutamine, taurine, creatine, or combinations thereof.

In another embodiment described herein, the synthetic bait composition comprises one or more of putrescine, butyric acid, isovaleric acid, cadaverine, spermidine, skatole, ascorbic acid, or trans-4,5-epoxy-(E)-2-decenal.

In another embodiment described herein, the synthetic bait composition comprises one or more attractants. In one embodiment, the attractants comprise a weight percentage of about 0.5% to about 40% by weight of the synthetic bait composition, including each integer within the specified range. In one aspect, the attractants comprise about 0.1%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 12%, about 14%, about 16%, about 18% about 20% about 22%, about 24%, about 26%, about 28%, about 30%, about 32%, about 34%, about 36%, about 38%, or about 40% by weight of the synthetic bait composition. In one aspect, the attractants comprise about 2.6% by weight of the synthetic bait composition. In one aspect, the combined weight percentage of attractants comprises about 4.6% by weight of the synthetic bait composition. In one aspect, the attractants comprise about 5.2% by weight of the synthetic bait composition. In one aspect, the attractants comprise about 5.5% by weight of the synthetic bait composition. In one aspect, the attractants comprise about 7.5% by weight of the synthetic bait composition. In one aspect, the attractants comprise about 29% by weight of the synthetic bait composition. In another aspect, the attractant comprise about 1.5%, about 3.5%, about 5%, about 6%, about 8%, about 10%, about 15%, about 20%, about 30%, or about 40% by weight of the synthetic bait composition.

In another embodiment described herein, one of the attractants comprises putrescine having a weight percentage of about 0% to about 30% by weight of the synthetic bait composition, including each integer within the specified range. In one aspect, putrescine comprises about 0%, about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 11%, about 12%, about 13% about 14%, about 15%, about 20%, about 25%, or about 35% by weight of the synthetic bait composition. In one aspect, putrescine comprises about 0.4% by weight of the synthetic bait composition. In one aspect, putrescine comprises about 0.7% by weight of the synthetic bait composition. In one aspect, putrescine comprises about 0.8% by weight of the synthetic bait composition. In one aspect, putrescine comprises about 2.1% by weight of the synthetic bait composition. In one aspect, putrescine comprises about 12.1% by weight of the synthetic bait composition. In another aspect, putrescine comprises about 0.4%, about 0.8%, about 1%, about 2%, about 5%, about 8%, about 10%, about 12%, or about 15% by weight of the synthetic bait composition.

In another embodiment described herein, one of the attractants comprises butyric acid having a weight percentage of about 0% to about 10% by weight of the synthetic bait composition, including each integer within the specified range. In one aspect, butyric acid comprises about 0%, about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, or about 10% by weight of the synthetic bait composition. In one aspect, butyric acid comprises about 0.1% by weight of the synthetic bait composition. In one aspect, butyric acid comprises about 0.2% by weight of the synthetic bait composition. In one aspect, butyric acid comprises about 0.5% by weight of the synthetic bait composition. In one aspect, butyric acid comprises about 1.7% by weight of the synthetic bait composition. In another aspect, butyric acid comprises about 0.1%, about 0.3%, about 0.4%, about 0.6%, about 0.8%, about 1.2%, about 1.4%, or about 1.8% by weight of the synthetic bait composition.

In another embodiment described herein, one of the attractants comprises isovaleric acid having a weight percentage of about 0% to about 10% by weight of the synthetic bait composition, including each integer within the specified range. In one aspect, isovaleric acid comprises about 0%, about 0.1%, about 0.2%, about 0.3%, about 0.4%, about 0.5%, about 0.6%, about 0.7%, about 0.8%, about 0.9%, about 1%, about 5%, or about 10% by weight of the synthetic bait composition. In one aspect, isovaleric acid comprises about 0.1% by weight of the synthetic bait composition. In one aspect, isovaleric acid comprises about 0.2% by weight of the synthetic bait composition. In one aspect, isovaleric acid comprises about 0.5% by weight of the synthetic bait composition. In one aspect, isovaleric acid comprises about 1.6% by weight of the synthetic bait composition. In another aspect, isovaleric acid comprises about 0.1%, about 0.3%, about 0.4%, about 0.6%, about 0.8%, about 1.2%, about 1.4%, or about 1.8% by weight of the synthetic bait composition.

In another embodiment described herein, one of the attractants comprises ascorbic acid having a weight percentage of about 0% to about 5% by weight of the synthetic bait composition, including each integer within the specified range. In one aspect, ascorbic acid comprises about 0%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, or about 5%, by weight of the synthetic bait composition. In one aspect, ascorbic acid comprises about 0.5% by weight of the synthetic bait composition. In one aspect, ascorbic acid comprises about 0.9% by weight of the synthetic bait composition. In one aspect, ascorbic acid comprises about 1% by weight of the synthetic bait composition. In one aspect, ascorbic acid comprises about 1.1% by weight of the synthetic bait composition. In another aspect, ascorbic acid comprises about 0.4%, about 0.7%, about 0.8%, about 1%, about 1.5%, or about 4% by weight of the synthetic bait composition.

In another embodiment described herein, one of the attractants comprises creatine having a weight percentage of about 0% to about 5% by weight of the synthetic bait composition, including each integer within the specified range. In one aspect, creatine comprises about 0%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, or about 5%, by weight of the synthetic bait composition. In one aspect, creatine comprises about 0.5% by weight of the synthetic bait composition. In one aspect, creatine comprises about 0.9% by weight of the synthetic bait composition. In one aspect, creatine comprises about 1% by weight of the synthetic bait composition. In one aspect, creatine comprises about 1.1% by weight of the synthetic bait composition. In another aspect, creatine comprises about 0.4%, about 0.7%, about 0.8%, about 1%, about 1.5%, or about 4% by weight of the synthetic bait composition.

In another embodiment described herein, one of the attractants comprises glutamine having a weight percentage of about 0% to about 5% by weight of the synthetic bait composition, including each integer within the specified range. In one aspect, glutamine comprises about 0%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, or about 5%, by weight of the synthetic bait composition. In one aspect, glutamine comprises about 0.5% by weight of the synthetic bait composition. In one aspect, glutamine comprises about 0.9% by weight of the synthetic bait composition. In one aspect, glutamine comprises about 1% by weight of the synthetic bait composition. In one aspect, glutamine comprises about 1.1% by weight of the synthetic bait composition. In another aspect, glutamine comprises about 0.4%, about 0.7%, about 0.8%, about 1%, about 1.5%, or about 4% by weight of the synthetic bait composition.

In another embodiment described herein, one of the attractants comprises taurine having a weight percentage of about 0% to about 5% by weight of the synthetic bait composition, including each integer within the specified range. In one aspect, taurine comprises about 0%, about 0.1%, about 0.2%, about 0.3%, about 0.4%, about 0.5%, about 0.6%, about 0.7%, about 0.8%, about 0.9%, about 1%, about 1.5%, about 2%, about 2.5%, about 3%, about 3.5%, about 4%, about 4.5%, or about 5%, by weight of the synthetic bait composition. In one aspect, taurine comprises about 0.5% by weight of the synthetic bait composition. In one aspect, taurine comprises about 0.9% by weight of the synthetic bait composition. In one aspect, taurine comprises about 1% by weight of the synthetic bait composition. In one aspect, taurine comprises about 1.1% by weight of the synthetic bait composition. In another aspect, taurine comprises about 0.4%, about 0.7%, about 0.8%, about 1%, about 1.5% or about 4% by weight of the synthetic bait composition.

In another embodiment described herein, one of the attractants comprises spermidine having a weight percentage of about 0% to about 30% by weight of the synthetic bait composition, including each integer within the specified range. In one aspect, spermidine comprises about 0%, about 0.2%, about 0.5%, about 0.8%, 1%, about 2%, about 3%, about 4%, about 5%, about 6%, about 7%, about 8%, about 9%, about 10%, about 12%, about 14%, about 16%, about 18%, about 20%, about 22%, about 24%, about 26%, about 28%, or about 30% by weight of the synthetic bait composition. In one aspect, spermidine comprises about 0% by weight of the synthetic bait composition. In one aspect, spermidine comprises about 2% by weight of the synthetic bait composition. In one aspect, spermidine comprises about 6.4% by weight of the synthetic bait composition. In one aspect, spermidine comprises about 10% by weight of the synthetic bait composition. In one aspect, spermidine comprises about 16% by weight of the synthetic bait composition. In another aspect, spermidine e comprises about 0%, about 2%, about 6%, about 10%, about 12%, about 17%, about 21%, or about 28% by weight of the synthetic bait composition.

In another embodiment described herein, one of the attractants comprises cadaverine having a weight percentage of about 0% to about 30% by weight of the synthetic bait composition, including each integer within the specified range. In one aspect, cadaverine comprises about 0%, about 0.2%, about 0.5%, about 0.8%, 1%, about 2%, about 3%, about 4%, about 5%, about 6%, about 7%, about 8%, about 9%, about 10%, about 12%, about 14%, about 16%, about 18%, about 20%, about 22%, about 24%, about 26%, about 28%, or about 30% by weight of the synthetic bait composition. In one aspect, cadaverine comprises about 0% by weight of the synthetic bait composition. In one aspect, cadaverine comprises about 2% by weight of the synthetic bait composition. In one aspect, cadaverine comprises about 6.4% by weight of the synthetic bait composition. In one aspect, cadaverine comprises about 10% by weight of the synthetic bait composition. In one aspect, cadaverine comprises about 16% by weight of the synthetic bait composition. In another aspect, cadaverine e comprises about 0%, about 2%, about 6%, about 10%, about 12%, about 17%, about 21%, or about 28% by weight of the synthetic bait composition.

In another embodiment described herein, one of the attractants comprises skatole having a weight percentage of about 0% to about 10% by weight of the synthetic bait composition, including each integer within the specified range. In one aspect, skatole comprises about 0%, about 0.2%, about 0.5%, about 0.8%, 1%, about 2%, about 3%, about 4%, about 5%, about 6%, about 7%, about 8%, about 9%, or about 10% by weight of the synthetic bait composition. In one aspect, skatole comprises about 0.2% by weight of the synthetic bait composition. In one aspect, skatole comprises about 0.7% by weight of the synthetic bait composition. In another aspect, skatole comprises about 0%, about 0.2%, about 0.4%, about 0.6%, or about 0.8% by weight of the synthetic bait composition.

In another embodiment described herein, the synthetic bait composition optionally comprises a coloring agent comprising 0-1% by weight of the synthetic bait composition, including each integer within the specified range. In one embodiment, the coloring agent comprises about 0.1%, about 0.2%, about 0.3%, about 0.4%, about 0.5%, about 0.6%, about 0.7%, about 0.8%, about 0.9%, or about 1% by weight of the synthetic bait composition. In one embodiment, the coloring agent comprises one or more of dyes or food colorings. In one aspect, the coloring agent comprises one or more of red, orange, yellow, green, indigo, violet, or combinations thereof. In another aspect, the coloring agents comprise the colors of natural marine organisms such as lobsters, crabs, shrimp, various fish, clams, scallops, conchs, starfish, coral, or seaweed, among others or objects such as rocks, shells, sand, or the like. In one aspect, the coloring agent is red, blue, orange, tan, beige, green, indigo, or combinations thereof.

In another embodiment, the synthetic bait composition comprises one or more preservatives comprising 0-5% by weight of the synthetic bait composition, including each integer within the specified range. In one embodiment, the preservatives comprise about 0.5%, about 1%, about 1.5%, about 2%, about 2.5%, about 3%, about 3.5%, about 4%, about 4.5%, or about 5% by weight of the synthetic bait composition. In one aspect, the preservatives comprise one or more of EDTA, sodium benzoate, sodium hydroxide, or combinations thereof.

In another embodiment described herein, the ratio of inert vehicle to film-forming polymer is about 1:1 to about 50:1, including each ratio within the specified range. In one aspect, the ratio of inert vehicle to film-forming polymer is about 1:1, about 12:1, about 14:1, about 16:1, about 18:1, about 20:1, about 22:1, about 24:1, about 26:1, about 28:1, about 30:1, or about 50:1. In one aspect, the ratio of inert vehicle to film-forming polymer is about 49:1. In one aspect, the ratio of inert vehicle to film-forming polymer is about 24:1. In one aspect, the ratio of inert vehicle to film-forming polymer is about 23:1. In one aspect, the ratio of inert vehicle to film-forming polymer is about 19:1. In one aspect, the ratio of inert vehicle to film-forming polymer is about 14:1. In one aspect, the ratio of inert vehicle to film-forming polymer is about 1:1. In one aspect, the ratio of inert vehicle to film-forming polymer is about 1.1:1, about 13:1, about 22:1, about 27:1, or about 51:1.

In another embodiment described herein, the ratio of inert vehicle to solvent is about 0.2:1 to about 5:1, including each ratio within the specified range. In one aspect, the ratio of inert vehicle to solvent is about 0.25:1, about 0.5:1, about 1:1, about 1.5:1, about 2:1, about 2.5:1, about 3:1, about 3.5:1, about 4:1, or about 5:1. In one aspect, the ratio of inert vehicle to solvent is about 1.1:1. In one aspect, the ratio of inert vehicle to solvent is about 1.6:1. In one aspect, the ratio of inert vehicle to solvent is about 2.1:1. In one aspect, the ratio of inert vehicle to solvent is about 3.6:1. In one aspect, the ratio of inert vehicle to solvent is about 0.3:1, about 1:1, about 1.5:1, about 2:1, or about 3.5:1.

In another embodiment described herein, the ratio of film-forming polymer to solvent is about 1:5 to about 1:60, including each ratio within the specified range. In one aspect, the ratio of film-forming polymer to solvent is about 1:5, about 1:10, about 1:15, about 1:20, about 1:25, about 1:30, about 1:35, about 1:40, about 1:45, about 1:50, about 1:55, or about 1:60. In one aspect, the ratio of film-forming polymer to solvent is about 1:45. In one aspect, the ratio of film-forming polymer to solvent is about 1:15. In one aspect, the ratio of film-forming polymer to solvent is about 1:9. In one aspect, the ratio of film-forming polymer to solvent is about 1:4. In one aspect, the ratio of film-forming polymer to solvent is about 1:3. In one aspect, the ratio of film-forming polymer to solvent is about 1:2, about 1:3, about 1:4, about 1:5, about 1:10, about 1:16, about 1:30, or about 1:50.

In another embodiment described herein, the ratio of film-forming polymer to the combined weight percentage of attractants is about 1:0.5 to about 1:10, including each ratio within the specified range. In one aspect, the ratio of film-forming polymer to the combined weight percentage of attractants is about 1:0.5, about 1:1, about 1:1.5, about 1:2, about 1:3, about 1:5, about 1:7, about 1:8, or about 1:10. In one aspect, the ratio of film-forming polymer to the combined weight percentage of attractants is about 1:0.5. In one aspect, the ratio of film-forming polymer to the combined weight percentage of attractants is about 1:1.1. In one aspect, the ratio of film-forming polymer to the combined weight percentage of attractants is about 1:1.6. In one aspect, the ratio of film-forming polymer to the combined weight percentage of attractants is about 1:1.9. In one aspect, the ratio of film-forming polymer to the combined weight percentage of attractants is about 1:2.6. In one aspect, the ratio of film-forming polymer to the combined weight percentage of attractants is about 1:0.6, about 1:1, about 1:2, about 1:3, about 1:4, about 1:5, about 1:6, about 1:7, about 1:8, or about 1:10.

In another embodiment described herein, the ratio of inert vehicle to the combined weight percentage of attractants is about 20:1 to about 1:1, including each ratio within the specified range. In one aspect, the ratio of inert vehicle to the combined weight percentage of attractants is about 19:1, about 12.5:1, about 12:1, about 11:1, about 2.4:1, or about 1:1. In one aspect, the ratio of inert vehicle to the combined weight percentage of attractants is about 19:1. In one aspect, the ratio of inert vehicle is about 12.5:1. In one aspect, the ratio of inert vehicle to the combined weight percentage of attractants is about 12.1:1. In one aspect, the ratio of inert vehicle to the combined weight percentage of attractants is about 11.1:1. In one aspect, the ratio of inert vehicle to the combined weight percentage of attractants is about 2.4:1. In one aspect, the ratio of inert vehicle to the combined weight percentage of attractants is about 20:1, about 18:1, about 15:1, about 13:1, about 8:1, about 6:1, about 3:1, about 4:1, or about 1:1.

In another embodiment described herein, the ratio of the combined weight percentage of the inert vehicle and film-forming polymer to the combined weight percentage of attractants is about 2:1 to about 30:1, including each ratio within the specified range. In one aspect, the ratio of the combined weight percentage of the inert vehicle and film-forming polymer to the combined weight percentage of attractants is about 2:1, 5:1, about 10:1, about 15:1, about 20:1, about 25:1, or about 30:1. In one aspect, the ratio of the combined weight percentage of the inert vehicle and film-forming polymer to the combined weight percentage of attractants is about 19:1. In one aspect, the ratio of the combined weight percentage of the inert vehicle and film-forming polymer to the combined weight percentage of attractants is about 13:1. In one aspect, the ratio of the combined weight percentage of the inert vehicle and film-forming polymer to the combined weight percentage of attractants is about 12:1. In one aspect, the ratio of the combined weight percentage of the inert vehicle and film-forming polymer to the combined weight percentage of attractants is about 3:1. In one aspect, the ratio of the combined weight percentage of the inert vehicle and film-forming polymer to the combined weight percentage of attractants is about 20:1, about 12:1, about 14:1, or about 4:1.

In another embodiment described herein, the ratio of the combined weight percentage of the attractants to solvent is about 1:2 to about 1:20, including each ratio within the specified range. In one aspect, the ratio of the combined weight percentage of the attractants to solvent is about 1:2, about 1:4, about 1:5, about 1:6, about 1:8, about 1:15, or about 1:20. In one aspect, the ratio of the combined weight percentage of the attractants to solvent is about 1:17. In one aspect, the ratio of the combined weight percentage of the attractants to solvent is about 1:8. In one aspect, the ratio of the combined weight percentage of the attractants to solvent is about 1:6. In one aspect, the ratio of the combined weight percentage of the attractants to solvent is about 1:4. In one aspect, the ratio of the combined weight percentage of the attractants to solvent is about 1:2. In one aspect, the ratio of the combined weight percentage of the attractants to solvent is about 1:3, about 1:4, about 1:5, about 1:7, about 1:10, or about 1:18.

In another embodiment described herein, the total mass of the synthetic bait described herein that comprises an attractant ingredient described herein is from about 100 g to about 5000 g, including all integers within the specified range. In another embodiment described herein, the total mass of the synthetic bait described herein that comprises an attractant ingredient described herein is from about 2000 g to about 4000 g, including all integers within the specified range. In one aspect, the total mass of the synthetic bait is about 2000 g, about 2200 g, about 2400 g, about 2600 g, about 2800 g, about 3000 g, about 3200 g, about 3400 g, about 3600 g, about 3800 g, or about 4000 g. In another aspect, the total mass of the synthetic bait is about 2431 g. In one aspect, the total mass of the synthetic bait is about 2495 g. In another aspect, the total mass of the synthetic bait is about 3030 g. In one aspect, the total mass of the synthetic bait is about 4637 g. In one aspect, the total mass of the synthetic bait is about 500 g. In one aspect, the total mass of the synthetic bait is about 145 g. In one aspect, the total mass of the synthetic bait is about 130 g, about 200 g, about 300 g, about 500 g, about 1000 g, 2410 g, about 2450 g, about 2900 g, or about 3050 g.

In one embodiment, the synthetic baits described herein dissolve and release attractants in an aqueous medium over of a period of time. In one embodiment, the dissolution time or release rate comprises 0.5 sec to about 6 weeks, including all integers of time within the specified range. In one embodiment the dissolution time or release rate comprises about 0.5 sec, about 1 sec, about 2 sec, about 3 sec, about 4 sec, about 5 sec, about 6 sec, about 7 sec, about 8 sec, about 9 sec, about 10 sec, about 15 sec, about 20 sec, about 25 sec, about 30 sec, about 35 sec, about 40 sec, about 45 sec, about 50 sec, about 55 sec, about 60 sec, about 1 min, about 2 min, about 3 min, about 4 min, about 5 min, about 6 min, about 7 min, about 8 min, about 9 min, about 10 min, about 15 min, about 20 min, about 25 min, about 30 min, about 35 min, about 40 min, about 45 min, about 50 min, about 55 min, about 60 min, about 1 hr, about 2 hr, about 3 hr, about 4 hr, about 5 hr, about 6 hr, about 7 hr, about 8 hr, about 9 hr, about 10 hr, about 11 hr, about 12 hr, about 13 hr, about 14 hr, about 15 hr, about 16 hr, about 17 hr, about 18 hr, about 19 hr, about 20 hr, about 21 hr, about 22 hr, about 23 hr, about 24 hr, about 1 day, about 2 days, about 3 days, about 4 days, about 5 days, about 6 days, about 7 days, about 8 days, about 9 days, about 10 days, about 11 days, about 12 days, about 13 days, about 14 days, about 15 days, about 16 days, about 17 days, about 18 days, about 19 days, about 20 days, about 21 days, about 22 days, about 23 days, about 24 days, about 25 days, about 26 days, about 27 days, about 28 days, about 29 days, about 30 days, about 1 week, about 2 weeks, about 3 weeks, about 4 weeks, about 5 weeks, about 6 weeks, about 7 weeks, about 8 weeks, about 1 month, or about 2 months.

Described herein are pluralities of synthetic bait compositions with different dissolution and release times. In one embodiment, synthetic bait formed from composition as shown in Table 1 has a dissolution time of about 0.5 seconds up to about 40 days. In one embodiment, synthetic bait formed from composition as shown in Table 2 has a dissolution time of about 0.5 seconds up to about 40 days. In one embodiment, synthetic bait formed from composition as shown in Table 3 has a dissolution time of about 10 min to about 1080 min (18 hours). In one embodiment, a synthetic bait formed from composition as shown in Table 4 has a dissolution time of about 0.5 seconds to about 120 seconds. In another embodiment, synthetic bait formed from composition as shown in Table 5 has a dissolution time of about 1 day to about 3 days (Example 1). In another embodiment, synthetic bait formed from composition as shown in Table 6 has a dissolution time of about 3 days to about 5 days (Example 2). In another embodiment, synthetic bait formed from composition as shown in Table 7 has a dissolution time of about 7 days to about 10 days (Example 3). In another embodiment, synthetic bait formed from composition as shown in Table 8 has a dissolution time of about 10 days to about 40 days (Example 4). In another embodiment, synthetic bait formed from the composition as shown in Table 9 has a dissolution time of about 10 sec to about 600 seconds (Example 5). In another embodiment, synthetic bait formed from the composition as shown in Table 10 has a dissolution time of about 0.5 seconds to about 120 seconds (Example 6).

Also described herein are methods of manufacturing synthetic baits. In one embodiment, an inert vehicle and solvent are combined to form a pasty mixture. One or more film-forming polymers is added to the mixture and combined. Attractants, optional coloring agents, and optional preservatives are combined until incorporated to form a uniform bait paste.

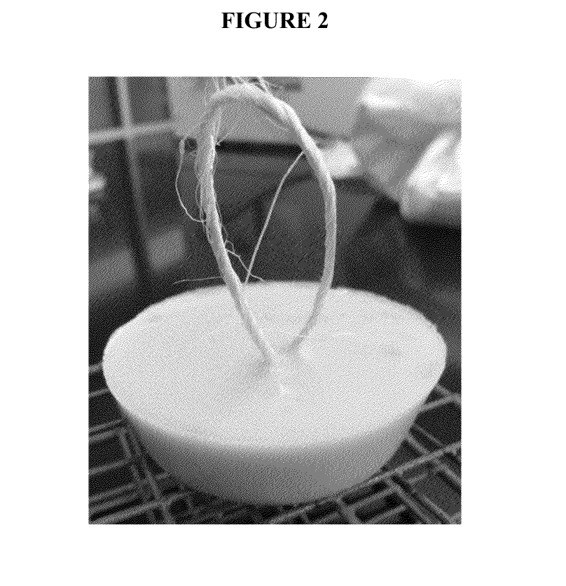

The amount of bait paste added to the mold depends on the desired size of the resulting synthetic bait “cake” and the size of the mold. In one aspect, the amount of mixture poured into the mold is about 10 mL to about 1000 mL, including all integers within the specified range. In one aspect, the amount of mixture poured into the mold is about 10 mL, about 50 mL, about 100 mL, about 150 mL, about 200 mL, about 250 mL, about 300 mL, about 350 mL, about 400 mL, about 450 mL, about 500 mL, about 550 mL, about 600 mL, about 650 mL, about 700 mL, about 750 mL, about 800 mL, about 850 mL, about 900 mL, about 950 mL, or about 1000 mL. In one aspect, FIG. 2 depicts an example of a 100 mL bait cake.

In one embodiment, a synthetic bait paste having composition mass of between about 2000 g to about 4000 g, and a volume of about 100 mL to about 200 mL generates about 10 to about 30 bait cakes.

In one embodiment described herein, after the bait paste is poured into a mold, a string, cable tie, or other suitable attachment device is affixed into the bait paste and becomes incorporated into the bait while solidifying. Such article may be used to suspend the solidified bait from a hook, line or other fishing device.

In another embodiment described herein, after the bait paste is poured into a mold, one or more grommets comprised of plastic, rubber, stainless steel, or other sturdy material is affixed into the bait paste and incorporated into the bait while solidifying. Such article may be used to attach a cable tie, string, wire, fishing line, etc. and suspend the solidified bait from a hook, line or other fishing device.

The bait paste is solidified in the mold for between 5 minutes to 16 hours at a temperature from about −20° C. to about 30° C., including all integers within the specified range. In one embodiment, the baits are solidified at 4° C. In another embodiment, the bait paste is solidified at about −20° C. In another embodiment, the bait paste is solidified at about 25° C. Baits may be left in the molds indefinitely at −20° C. to about 4° C. The molded bait is then removed from the mold and cured for about 12 to about 24 hours at about 25° C. to about 40° C., including all integers within the specified range. The synthetic bait cakes may be used immediately or stored in an appropriate receptacle such as a plastic bag or airtight box. The synthetic bait cakes may be stored indefinitely in airtight containers such as plastic bags or boxes at −20° C. to about 25° C., including all integers within the specified range.

Also described herein are methods of manufacturing synthetic bait liquids. In one embodiment, one or more solvents are combined with the attractants, optional coloring agents, and optional preservatives to form a solution or suspension. The liquid synthetic bait can be used immediately or stored in an airtight container at a temperature from about −20° C. to about 30° C., including all integers within the specified range.

Another embodiment described herein is a dispensing article comprising a perforated, vented, apertured, or articulated container or vessel of suitable size to hold the synthetic bait while facilitating dispersion and access to the aqueous medium. In one embodiment, the dispensing article permits dispersion of the synthetic bait while providing protection from water agitation or attack by trapped organisms. In one aspect, the dispensing article comprises a box, pouch, bag, basket, tube, or other similar vessel suited for holding one or more synthetic baits. In one aspect, the dispensing article comprises plastic, rubber, wire, stainless steel, wood, composite, or other durable materials or combinations thereof. In one aspect, the dispensing article comprises an opening mechanism that can be easily affixed for opening and closing. In another embodiment, the dispensing article comprises an attachment point for affixing a line or tether.

Also described herein are methods of manufacturing synthetic baits as powders, particles, granules, or pellets. After forming a bait paste as described herein, the synthetic bait can be formed into pellets, granules, or particles by methods known in the art and then dried. The particles or granules can be further pulverized to form powders.

In another embodiment, the synthetic bait composition is prepared in particles, pellets, or granules of various sizes (in mass and diameter) that permit dissemination both laterally and vertically in the water column. In one embodiment, the synthetic bait particles, pellets, or granules can comprise diameters of about 0.1 mm to about 20 mm, including all integers within the specified range. In one embodiment, the synthetic bait particles, pellets, or granules can comprise diameters of about 0.2 mm, about 0.4 mm, about 0.6 mm, about 0.8 mm, about 1.0 mm, about 1.2 mm, about 1.4 mm, about 1.6 mm, about 1.8 mm, about 2.0 mm, about 2.2 mm, about 2.4 mm, about 2.6 mm, about 2.8 mm, about 3.0 mm, about 3.2 mm, about 3.4 mm, about 3.6 mm, about 3.8 mm, about 4.0 mm, about 4.2 mm, about 4.4 mm, about 4.6 mm, about 4.8 mm, about 5.0 mm; about 5.2 mm, about 5.4 mm, about 5.6 mm, about 5.8 mm, about 6.0 mm, about 6.2 mm, about 6.4 mm, about 6.6 mm, about 6.8 mm, about 7.0 mm, about 7.2 mm, about 7.4 mm, about 7.6 mm, about 7.8 mm, about 8.0 mm, about 8.2 mm, about 8.4 mm, about 8.6 mm, about 8.8 mm, about 9.0 mm, about 9.2 mm, about 9.4 mm, about 9.6 mm, about 9.8 mm, about 10.0 mm; about 1.2 cm, about 1.3 cm, about 1.4 cm, about 1.5 cm, about 1.6 cm, about 1.7 cm, about 1.8 cm, about 1.9 cm, or about 2.0 cm. As used herein, a particle refers to synthetic bait having a diameter from 0.2 mm to 1 mm; a granule refers to synthetic bait having a diameter from 1.1 mm to 5 mm; a pellet refers to synthetic bait having a diameter greater than 5 mm.

In one embodiment, multiple sizes of synthetic bait particles, granules, or pellets are combined in a mixture. Because the dissolution time of a granule of 2 mm is far greater than that of a particle of 0.2 mm, combinations of multiple sized particles, granules, or pellets permit variable dissolution and sink rates throughout the water column. For example, particles, granules, and pellets cast or spread from a boat or pier can cover a large surface area. The particles dissolve and release attractants on or near the surface. The more dense granules and pellets sink and release the attractants as they descend through the water column. This permits stimulation and attraction of marine organisms both on the surface and at various depths.

In another embodiment, particularly when the synthetic bait is a solution or suspension, the synthetic bait is contained in a ready-to-use dispersal device comprising a bottle, cylinder, or pouch comprised of plastic, rubber, Mylar, or any other suitable material. In one embodiment, the dispersal device comprises micro-perforations or vents that are sealed by an easily removable strip or tab prior to use. Upon use, the strip or tab can be removed from dispersal device exposing the micropreforations and permitting the synthetic bait liquid or suspension to diffuse slowly from the dispersal device when submerged in an aqueous medium. In one embodiment, the dispersal device comprises one or more attachment points for affixing a line or tether to suspend the dispersal device in an aqueous medium. In one embodiment, the dispersal device is shaped like a marine organism, including but not limited to a minnow, mullet, mackerel, squid, ballyhoo, needlefish, or other cylindrical or fusiform shape. In one embodiment, the dispersal device is capable of being axially affixed to a fishing line and is capable of being trolled in an aqueous medium. In another embodiment, the dispersal device is durable and refillable with a liquid or synthetic bait solution.

Another embodiment described herein is a method for attracting marine organisms comprising submerging one or more synthetic baits in an aqueous media. Aqueous media include brackish water, fresh water, or seawater. The synthetic bait may be submerged directly into the water or used in crab traps, lobster pots, fish traps, or other devices for capturing marine organisms. In one aspect, the synthetic bait comprises about 0% to about 75% by weight of an inert vehicle, about 0% to about 25% by weight of at least one film-forming polymer, about 20% to about 85% by weight of at least one solvent, about 0.5% to about 40% by weight of at least one attractant. In another aspect, the synthetic bait dissolves over a period of seconds to about 40 days in an aqueous medium.

Another embodiment described herein is a means for attracting a marine organism using any of the synthetic bait compositions described herein. In one embodiment, synthetic bait is immersed in an aqueous medium and releases attractants that simulate decomposing flesh metabolites thereby stimulating and enticing marine organisms to investigate the vicinity of the bait. In one aspect, the synthetic bait is placed within a trap or pot. In another aspect, the synthetic bait is randomly dispersed across the surface and throughout the water column for attracting marine organisms to awaiting anglers.

In another embodiment described herein, the synthetic bait composition is contained and dispensed in a kit. The kit provides packaging of all the components required for an end user to prepare one or more synthetic baits as described herein. In one aspect, the kit comprises one or more containers comprising the synthetic bait components, one or more molds resembling a marine organism, and instructions for use. In one aspect, the synthetic bait components comprise about 0.01% to about 75% by weight of an inert vehicle, about 0.01% to about 15% by weight of one or more film-forming polymer, about 0.5% to about 40% by weight of one or more attractants; and optional preservatives and coloring agents. In one aspect, the end user provides about 20% to about 85% by weight water to the synthetic bait components to form a mixture to be poured into the mold. The water can be fresh water or seawater.

In another embodiment described herein, the synthetic bait composition is contained and dispensed in a kit comprising one or more containers comprising the synthetic bait components, one or more dispensing articles or dispersal devices, and instructions for use.

It will be readily apparent to one of ordinary skill in the relevant arts that suitable modifications and adaptations to the compositions, methods, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any and all variations or iterations. The scope of the compositions, formulations, methods, and processes described herein include all actual or potential combinations of embodiments, aspects, options, examples, and preferences herein described. The ratios of the mass of any component of any of the formulations disclosed herein to the mass of any other component in the formulation or to the total mass of the other components in the formulation are hereby disclosed as if they were expressly disclosed. All patents and publications cited herein are incorporated by reference herein for the specific teachings thereof.

### EXAMPLES

### Example 1

Exemplary synthetic bait compositions useful for producing synthetic bait cakes as described herein are shown in Table 5. Composition components are set forth by weight percentage of the total mass of the composition. Such compositions may be manufactured into synthetic bait cakes as described herein.

TABLE 5
Exemplary Fast Release Synthetic Bait Composition

| | Range | Exemplary | Percent |
|---|---|---|---|
| Component | (% wt) | Mass (g) | Weight (%) |
| Calcium Sulfate | 45-70 | 1200.0 | 49.36 |
| Gelatin, 100-300 Bloom | 1-10 | 24.0 | 0.99 |
| Collagen, 100-300 Bloom | 1-10 | 24.0 | 0.99 |
| Solvent (e.g., water) | 20-50 | 1100.0 | 45.24 |
| Putrescine | 0.5-10 | 10.5 | 0.43 |
| Isovaleric Acid | 0-1 | 2.3 | 0.10 |
| Butyric Acid | 0-5 | 2.5 | 0.10 |
| Ascorbic Acid | 0-5 | 12.0 | 0.49 |
| Glutamine | 0-5 | 12.0 | 0.49 |
| Taurine | 0-5 | 12.0 | 0.49 |
| Creatine | 0-5 | 12.0 | 0.49 |
| EDTA | 0-5 | 10.0 | 0.41 |
| Coloring Agent | 0-1 | 10.0 | 0.41 |
| TOTAL | 100.0% | 2431.3 | 100.0% |

Dissolution Profile

| | |
|---|---|
| Dissolution Time (days) | 1-3 |

### Example 2

An exemplary synthetic bait composition useful for producing synthetic bait cakes as described herein are shown in Table 6. Composition components are set forth by weight percentage of the total mass of the composition. This composition may be manufactured into synthetic bait cakes as described herein.

TABLE 6
Exemplary Standard Release Synthetic Bait Composition

| | Range | Exemplary | Percent |
|---|---|---|---|
| Component | (% wt) | Mass (g) | Weight (%) |
| Calcium Sulfate | 45-70 | 1400.0 | 56.1 |
| Gelatin, 100-300 Bloom | 1-10 | 30.0 | 1.2 |
| Collagen, 100-300 Bloom | 1-10 | 30.0 | 1.2 |
| Solvent (e.g., water) | 20-50 | 900.0 | 36.1 |
| Putrescine | 0.5-10 | 17.5 | 0.7 |
| Isovaleric Acid | 0-1 | 4.6 | 0.2 |
| Butyric Acid | 0-5 | 5.0 | 0.2 |
| Ascorbic Acid | 0-5 | 22.0 | 0.9 |
| Glutamine | 0-5 | 22.0 | 0.9 |
| Taurine | 0-5 | 22.0 | 0.9 |
| Creatine | 0-5 | 22.0 | 0.9 |
| EDTA | 0-5 | 10.0 | 0.4 |
| Coloring Agent | 0-1 | 10.0 | 0.4 |
| TOTAL | 100.0% | 2495.2 | 100.0% |

Dissolution Profile

| | |
|---|---|
| Dissolution Time (days) | 3-5 |

### Example 3

An exemplary synthetic bait composition useful for producing synthetic bait cakes as described herein are shown in Table 7. Composition components are set forth by weight percentage of the total mass of the composition. This composition may be manufactured into synthetic bait cakes as described herein.

TABLE 7
Exemplary Slow Release Synthetic Bait Composition

| | Range | Exemplary | Percent |
|---|---|---|---|
| Component | (% wt) | Mass (g) | Weight (%) |
| Calcium Sulfate | 45-70 | 1850.0 | 61.0 |
| Gelatin, 100-300 Bloom | 1-10 | 50.0 | 1.6 |
| Collagen, 100-300 Bloom | 1-10 | 50.0 | 1.6 |
| Solvent (e.g., water) | 20-50 | 900.0 | 29.7 |
| Putrescine | 0.5-10 | 21.9 | 0.7 |
| Isovaleric Acid | 0-1 | 6.9 | 0.2 |
| Butyric Acid | 0-5 | 7.5 | 0.2 |
| Ascorbic Acid | 0-5 | 30.0 | 1.0 |
| Glutamine | 0-5 | 30.0 | 1.0 |
| Taurine | 0-5 | 30.0 | 1.0 |
| Creatine | 0-5 | 30.0 | 1.0 |
| EDTA | 0-5 | 12.0 | 0.4 |
| Coloring Agent | 0-1 | 12.0 | 0.4 |
| TOTAL | 100.0% | 3030.4 | 100.0% |

Dissolution Profile

| | |
|---|---|
| Dissolution Time (days) | 7-10 |

### Example 4

An exemplary synthetic extended release bait composition useful for producing synthetic bait cakes as described herein are shown in Table 8. Composition components are set forth by weight percentage of the total mass of the composition. This composition may be manufactured into synthetic bait cakes as described herein.

TABLE 8
Exemplary Extended Release Synthetic Bait Composition

| | Range | Exemplary | Percent |
|---|---|---|---|
| Component | (% wt) | Mass (g) | Weight (%) |
| Calcium Sulfate | 45-70 | 3200.0 | 69.3 |
| Gelatin, 100-300 Bloom | 1-10 | 110.0 | 2.4 |
| Collagen, 100-300 Bloom | 1-10 | 110.0 | 2.4 |
| Solvent (e.g., water) | 20-50 | 900.0 | 19.5 |
| Putrescine | 0.5-10 | 35.1 | 0.8 |
| Isovaleric Acid | 0-1 | 9.3 | 0.2 |
| Butyric Acid | 0-5 | 10.0 | 0.2 |
| Ascorbic Acid | 0-5 | 50.0 | 1.1 |
| Glutamine | 0-5 | 50.0 | 1.1 |
| Taurine | 0-5 | 50.0 | 1.1 |
| Creatine | 0-5 | 50.0 | 1.1 |
| EDTA | 0-5 | 45.0 | 1.0 |
| Coloring Agent | 0-1 | 18.0 | 0.4 |
| TOTAL | 100.0% | 4637.3 | 100.0% |

Dissolution Profile

| | |
|---|---|
| Dissolution Time (days) | 10-40 |

### Example 5

An exemplary synthetic bait composition useful for producing a rapid release synthetic bait suspension as described herein are shown in Table 9. Composition components are set forth by weight percentage of the total mass of the composition. This composition may be manufactured into rapid release synthetic bait as described herein.

In one embodiment, the synthetic bait composition is prepared by methods known in the art into powders, particles, granules, or pellets of various sizes (in mass and diameter) that permit dissemination both laterally and vertically in the water column. For example, pellets spread from a boat or pier can cover a large surface area. Further, as the particles, granules, or pellets sink and dissolve they release the attractants as they descend through the stratification of the water column. This permits stimulation of marine organisms both on the surface and throughout the depths of the water column.

TABLE 9
Exemplary Rapid Release Synthetic Bait Composition

| | Range | Exemplary | Percent |
|---|---|---|---|
| Component | (% wt) | Mass (g) | Weight (%) |
| Calcium Sulfate | 10-20 | 90.0 | 18.0 |
| Gelatin, 100-300 Bloom | 1-10 | 40.0 | 8.0 |
| Collagen, 100-300 Bloom | 1-10 | 40.0 | 8.0 |
| Solvent (e.g., water) | 45-65 | 280.0 | 56.1 |
| Putrescine | 0.5-10 | 10.5 | 2.1 |
| Isovaleric Acid | 0-1 | 2.3 | 0.5 |
| Butyric Acid | 0-5 | 2.5 | 0.5 |
| Spermidine | 0-10 | 10.5 | 2.1 |
| Cadaverine | 0-10 | 10.5 | 2.1 |
| Skatole | 0-5 | 1.0 | 0.2 |
| EDTA | 0-5 | 10.0 | 2.0 |
| Coloring Agent | 0-1 | 2.0 | 0.4 |
| TOTAL | 100.0% | 499.4 | 100.0% |

Dissolution Profile

| | |
|---|---|
| Dissolution Time (seconds) | 10-600 |

### Example 6

An exemplary instantaneous release synthetic bait composition useful for producing a solution or suspension is shown in Table 10. Composition components are set forth by weight percentage of the total mass of the composition. This composition may be manufactured into an instant release synthetic bait solution or suspension as described herein.

TABLE 10
Exemplary Instantaneous Release Synthetic Bait Composition

| | Range | Exemplary | Percent |
|---|---|---|---|
| Component | (% wt) | Mass (g) | Weight (%) |
| Water | 60-85 | 100.0 | 69.0 |
| Putrescine | 10-30 | 17.5 | 12.1 |
| Isovaleric Acid | 1-10 | 2.3 | 1.6 |
| Butyric Acid | 1-10 | 2.5 | 1.7 |
| Spermidine | 10-30 | 9.3 | 6.4 |
| Cadaverine | 10-30 | 9.3 | 6.4 |
| Skatole | 1-10 | 1.0 | 0.7 |
| EDTA | 0-5 | 2.5 | 1.7 |
| Coloring Agent | 0-1 | 0.5 | 0.3 |
| TOTAL | 100.0% | 144.9 | 100.0% |

Dissolution Profile

| | |
|---|---|
| Dissolution Time (seconds) | 0.5-120 |

### Example 8

Exemplary attractants suitable for use in synthetic bait compositions as described herein are shown in Table 11.

TABLE 11
Exemplary Attractants

| | Percent |
|---|---|
| Component | Weight (%) |
| acetylcholine chloride | 0-2.5 |
| N-acetyl-D-glucosamine | 0-5 |
| adenine | 0-5 |
| adenosine | 0-1 |
| adenosine monophosphate | 0-5 |
| β-alanine | 0-5 |
| L-alanine | 0-5 |
| 2-aminoethanol | 0-5 |
| R-amino-n-butyric acid | 0-1 |
| ammonia | 0-5 |
| ammonium chloride | 0-1 |
| ammonium sulfide | 0-5 |
| aniline | 0-5 |
| L-arginine | 0-5 |
| L-ascorbic acid | 0-5 |
| L-asparagine | 0-5 |
| L-asparatic acid | 0-5 |
| betaine | 0-10 |
| butanethiol | 0-5 |
| butyric acid | 0-5 |
| cadaverine | 0-10 |
| caproic acid | 0-5 |
| D/L-carnitine HCl | 0-5 |
| L-carnosine | 0-5 |
| citric acid | 0-5 |
| L-citrulline | 0-5 |
| coumarin | 0-5 |
| creatine | 0-5 |
| p-cresyl isovalerate | 0-5 |
| L-cysteine | 0-5 |
| dimethylamine | 0-5 |
| dipropylene glycol | 0-5 |
| ethanethiol | 0-5 |
| ethyl mercaptan | 0-5 |
| ethylamine | 0-5 |
| fumaric acid | 0-2.5 |
| D-fructose | 0-5 |
| D-galactose | 0-5 |
| D-glucose | 0-5 |
| L-glutamic acid | 0-5 |
| L-glutamine | 0-5 |
| glutathione | 0-5 |
| glycine | 0-10 |
| guanidine HCl | 0-1 |
| guanine | 0-1 |
| hexanoic acid | 0-5 |
| histamine | 0-1 |
| L-histidine | 0-5 |
| homarine | 0-1 |
| hydroxy-L-proline | 0-2.5 |
| 5-hydroxytryptamine | 0-1 |
| hypoxanthine | 0-2.5 |
| indole | 0-5 |
| i-inositol | 0-10 |
| inosine | 0-1 |
| inosine monophosphate | 0-1 |
| inositol | 0-10 |
| L-isoleucine | 0-5 |
| L-isoleucine methyl ester HCl | 0-5 |
| isopropylamine | 0-5 |
| isovaleric acid | 0-1 |
| D/L-lactic acid | 0-5 |
| α-lactose | 0-10 |
| β-lactose | 0-10 |
| L-leucine | 0-5 |
| levulinic acid | 0-2.5 |
| L-lysine | 0-5 |
| maltose | 0-5 |
| L-malic acid | 0-5 |
| D-mannitol | 0-5 |
| mercaptoethanol | 0-5 |
| L-methionine | 0-5 |
| methyl mercaptan | 0-5 |
| N-methyl morpholine | 0-5 |
| methylamine | 0-5 |
| 2-naphthalenethiol | 0-5 |
| nicotinic acid | 0-5 |
| D/L-ornithine | 0-5 |
| pentanethiol | 0-5 |
| α-picolinic acid | 0-1 |
| phosphoethanolamine | 0-1 |
| O-phospho-L-serine | 0-1 |
| L-proline | 0-5 |
| propanethiol | 0-5 |
| propionic acid | 0-5 |
| propylamine | 0-5 |
| putrescine | 0.25-5 |
| pyruvic acid | 0-5 |
| quinine | 0-5 |
| D-ribose | 0-5 |
| sarcosine | 0-5 |
| L-serine | 0-5 |
| skatole | 0-5 |
| sodium saccharin | 0-5 |
| D-sorbitol | 0-10 |
| spermidine | 0-10 |
| succinic acid | 0-2.5 |
| sucrose | 0-10 |
| taurine | 0-5 |
| thioglycolic acid | 0-5 |
| trimethylamine | 0-5 |
| L-tryptophan | 0-5 |
| L-tyrosine | 0-5 |
| urea | 0-5 |
| uric acid | 0-5 |
| uridine monophosphate | 0-5 |
| N-valeric acid | 0-5 |
| L-valine | 0-5 |
| trans-4,5-epoxy-(E)-2-decenal | 0-10 |

### Example 10

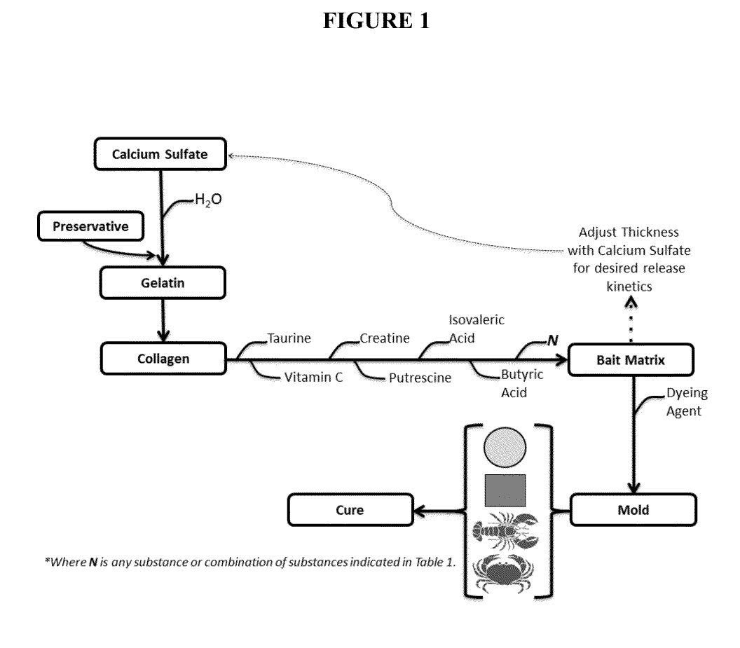

Some embodiments of the synthetic bait compositions as described herein were manufactured by preparing a first mixture of inert vehicle, solvent, and optional preservatives at or below room temperature until all the solvent was fully absorbed to form a paste. A second mixture of film-forming polymers was prepared and slowly added to the first mixture while stirring rapidly until the paste consistency stiffened. A third mixture of the desired attractants was prepared and mixed into the paste and evenly dispersed by stirring rapidly. Liquid putrescine and isovaleric acid were not included in the initially added attractant mixture and were added separately, one at a time, with mixing until the attractant mixture was fully incorporated into the bait paste (FIG. 1). Optional coloring agents may be added after the attractants are fully incorporated into the bait paste.

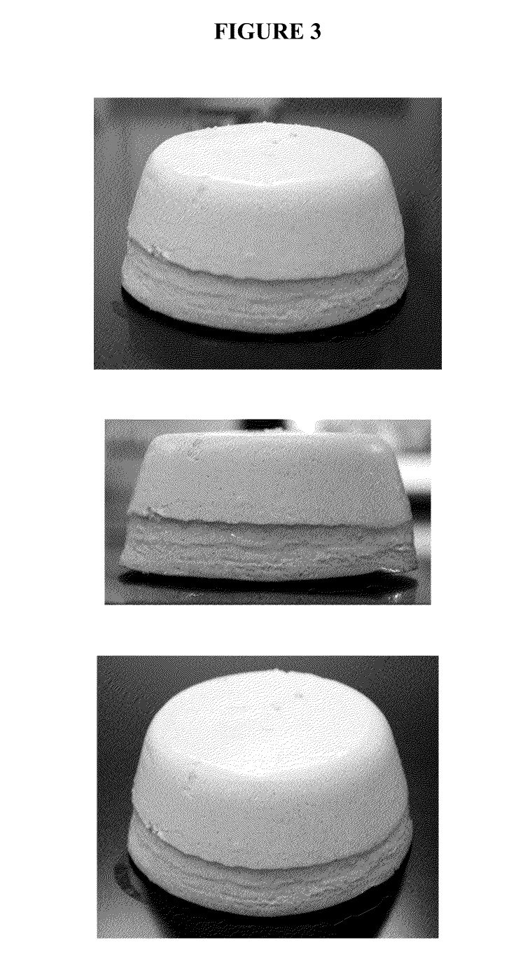

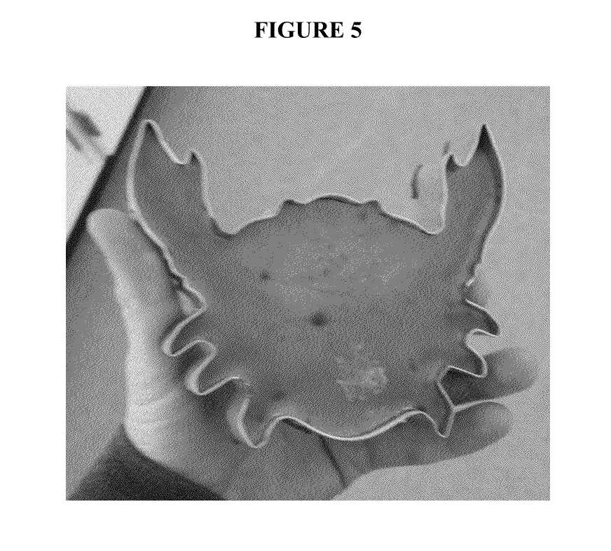

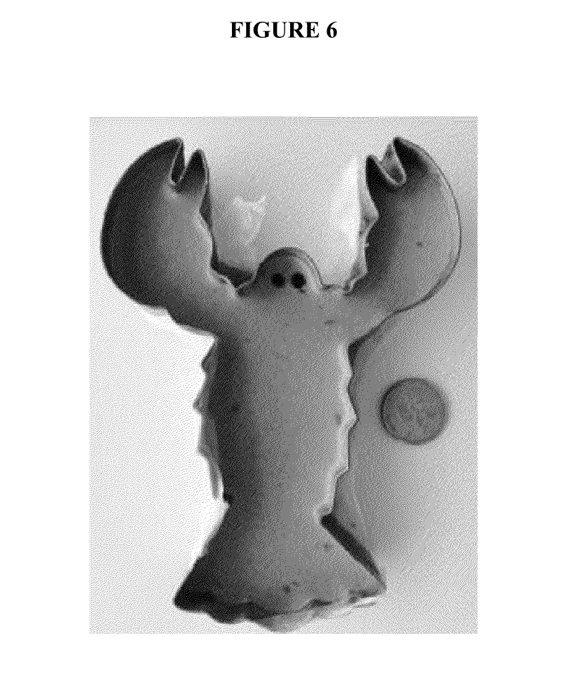

The bait paste was then poured into a mold of desired shape. The mold can be of any size, thickness, or shape, including but not limited to a sphere, puck, circle, square, a crab, fish, shrimp, lobster, clam, scallop, conch, starfish, seaweed, coral, or rock (FIGS. 2-3 and FIGS. 5-6). The amount of bait paste poured into mold can be adjusted to create different sized synthetic bait cakes.

Once poured, the synthetic bait cakes were firmed at about 4° C. for at least about 30 minutes, and then cured for between about 12 to about 24 hours at or slightly above about 25° C.

1. A synthetic bait composition for attracting marine organisms comprising:
(a) about 0.01% to about 75% by weight of at least one inert vehicle;
(b) about 0.01% to about 25% by weight of at least one film-forming polymer;
(d) about 20% to about 85% by weight of at least one solvent; and
(d) about 0.5% to about 40% by weight of at least one attractant;
wherein synthetic bait formed from the composition dissolves over about a period of about 0.5 seconds to about 40 days in an aqueous medium.

2. The composition of claim 1, wherein the inert vehicle comprises one or more of calcium sulfate (gypsum), calcium hydroxide, calcium carbonite, silicates, bentonite, Portland cement, clays, sand, or combinations thereof.

3. The composition of claim 1, wherein the film-forming polymer comprises one or more of gelatin, hydrolyzed gelatin, collagen, alginate, agarose, agar, carrageenan, plant gums, hydroxypropylmethylcellulose, ethylcellulose, cellulose, acrylates, methacrylates, or combinations thereof.

4. The composition of claim 1, wherein the solvent comprises one or more of water, seawater, glycerol, sorbitol, polyethylene glycol, propylene glycol, or combinations thereof.

5. The composition of claim 1, wherein the attractants comprise one or more of acetylcholine chloride, N-acetyl-D-glucosamine, adenine, adenosine, adenosine monophosphate, β-alanine, L-alanine, 2-aminoethanol, R-amino-n-butyric acid, ammonia, ammonium chloride, ammonium sulfide, aniline, L-arginine, L-ascorbic acid, L-asparagine, L-asparatic acid, betaine, butanethiol, butyric acid, cadaverine, caproic acid, D/L-carnitine HCl, L-carnosine, citric acid, L-citrulline, coumarin, creatine, p-cresyl isovalerate, L-cysteine, dimethylamine, dipropylene glycol, ethanethiol, ethyl mercaptan, ethylamine, fumaric acid, D-fructose, D-galactose, D-glucose, L-glutamic acid, L-glutamine, glutathione, glycine, guanidine HCl, guanine, hexanoic acid, histamine, L-histidine, homarine, hydroxy-L-proline, 5-hydroxytryptamine, hypoxanthine, indole, i-inositol, inosine, inosine monophosphate, inositol, L-isoleucine, L-isoleucine methyl ester HCl, isopropylamine, isovaleric acid, D/L-lactic acid, α-lactose, β-lactose, L-leucine, levulinic acid, L-lysine, maltose, L-malic acid, D-mannitol, mercaptoethanol, L-methionine, methyl mercaptan, N-methyl morpholine, methylamine, 2-naphthalenethiol, nicotinic acid, D/L-ornithine, pentanethiol, α-picolinic acid, phosphoethanolamine, O-phospho-L-serine, L-proline, propanethiol, propionic acid, propylamine, putrescine, pyruvic acid, quinine, D-ribose, sarcosine, L-serine, skatole, sodium saccharin, D-sorbitol, spermidine, succinic acid, sucrose, taurine, thioglycolic acid, trimethylamine, L-tryptophan, L-tyrosine, urea, uric acid, uridine monophosphate, N-valeric acid, L-valine, or mixtures or combinations thereof.

6. The composition of claim 1, wherein the attractants comprise one or more of creatine monohydrate, butyric acid, ascorbic acid, glutamate, putrescine, cadaverine, isovaleric acid, trimethylamine, glutamine, taurine, spermidine, skatole, or combinations thereof.

7. The composition of claim 1, wherein the composition contains one or more of coloring agents, opacifiers, preservatives, or combinations thereof.

8. The composition of claim 1, wherein the composition is molded to resemble a natural marine organism or marine object.

9. The composition of claim 1, wherein the aqueous media is fresh water, brackish water, or seawater.

10. A method for attracting marine organisms comprising immersing in an aqueous environment a synthetic bait formed from a composition comprising:
(a) about 0.01% to about 75% by weight of at least one inert vehicle;
(b) about 0.01% to about 25% by weight of at least one film-forming polymer;
(d) about 20% to about 85% by weight of at least one solvent; and
(d) about 0.5% to about 40% by weight of at least one attractant;
wherein the synthetic bait dissolves over about a period of about 0.5 seconds to about 40 days in an aqueous medium.

11. A method for manufacturing synthetic bait for attracting marine organisms comprising the steps:
(a) combining one or more inert vehicles and optional preservatives with a solvent to form a mixture;
(b) combining one or more film-forming polymer to the mixture of (a); and
(c) combining attractants, optional coloring agents, to the mixture of (b) to form a synthetic bait composition.

12. The synthetic bait made by the method of claim 11 wherein the synthetic bait composition comprises:
(a) about 0.01% to about 75% by weight of at least one inert vehicle;
(b) about 0.01% to about 25% by weight of at least one film-forming polymer;
(c) about 20% to about 85% by weight of at least one solvent;
(d) about 0.5% to about 40% by weight of at least one attractant; and
wherein the synthetic bait dissolves over about a period of about 0.5 seconds to about 40 days in an aqueous medium.

13. The method of claim 11, further comprising the steps:
(d) pouring the synthetic bait composition of 11(c) into a mold;
(e) solidifying the composition in the mold at a temperature of at least about 4° C. to about 25° C.;
(f) curing the composition in the mold for at least about 1 hour at about 25° C.; and
(g) removing the synthetic bait from the mold.

14. The method of claim 11, further comprising the step:
(d) creating particles, granules, or pellets from the synthetic composition of 11(c).

15. A synthetic bait produced by the method of claim 13.

16. A synthetic bait produced by the method of claim 14.

17-18. (canceled)

19. A kit comprising articles for manufacturing synthetic bait for attracting marine organisms, the kit comprising:
(a) one or more containers comprising a synthetic bait composition;
(c) one or more molds resembling a marine organism; and
(d) instructions for use.

20. The kit of claim 18, wherein the synthetic bait composition comprises:
(a) about 0.01% to about 75% by weight of at least one inert vehicle;
(b) about 0.01% to about 25% by weight of at least one film-forming polymer;
(c) about 0.5% to about 40% by weight of at least one attractant; and
(d) optional preservatives and coloring agents.

21. The kit of claim 19, wherein about 20-85% by weight of a solvent is provided by an end-user.

22-29. (canceled)
